(19) United States
(12) Patent Application Publication
(10) Pub. No.: US 2025/0139482 A1
(43) Pub. Date: May 1, 2025

(54) A METHOD OF MANIPULATING A QUBIT AND AN ASSEMBLY COMPRISING A QUBIT

(71) Applicants: QDEVIL APS, Copenhagen O (DK); UNIVERSITY OF COPENHAGEN, Copenhagen K. (DK)

(72) Inventors: Joost VAN DER HEIJDEN, Copenhagen O (DK); Ferdinand KUEMMETH, Copenhagen O (DK); Merlin VON SOOSTEN, Copenhagen O (DK); Soren ANDRESEN, Copenhagen O (DK); Jonatan KUTCHINSKY, Copenhagen O (DK); Anders KUHLE, Copenhagen O (DK)

(21) Appl. No.: 18/683,341

(22) PCT Filed: Aug. 15, 2022
(86) PCT No.: PCT/EP2022/072758

§ 371 Date: Feb. 13, 2024

(30) Foreign Application Priority Data
Aug. 13, 2021 (EP) 21191227.4

(51) Int. Cl. G06N 10/40; G06N 10/20

(52) U.S. Cl. CPC G06N 10/40; G06N 10/20

(57) ABSTRACT

An assembly comprising a qubit and a method of altering a qubit, where a presence of a charge in a storage element close to the qubit influences on the state in which the altering is performed. Then, altering may be performed by feeding signals to electrodes, where the same signal is fed to the qubit but where the state is altered only if the charge is present in the storage element. Multiple qubits may then receive the same signal and only the ones with a charge are altered by the signal.

The present invention relates to a method and a system for loading information into a qubit, such as when initializing the qubit or manipulating it in other manners.

Qubits of different types exist. Some qubits operate on a single particle, where other qubits operate using multiple particles. Some qubits encode the quantum information in the number of particles, other qubits in the location of particles, other qubits in the spin of a particle, and other qubits in other properties, such as for instance polarization, phase, quadrature or flux.

Some multiple particle qubits, such as singlet-triplet qubits, operate on two particles having opposite spins, where the initialization may be providing one of the particles with a particular spin and the other particle with the opposite spin.

Relevant technology may be seen in e.g. “Charge-State Conditional Operation of a Spin Qubit”, Weperen et al. Phys. Rev. Lett. 107, 030506—15 Jul. 2011 (Phys. Rev. Lett. 107, 030506 (2011)—Charge-State Conditional Operation of a Spin Qubit (aps.org)), Federico Fedele et al: “Simultaneous operations in a two-dimensional array of singlet-triplet qubits”, Arxiv.org, Cornell univ. libr, 4 May 2021, and Fogarty et al: “Integrated silicon qubit platform with single-spin addressability, exchange control and robust single-shot singlet-triplet readout”, 5/12-2017, pp 1-10.

In a first aspect, the invention relates to an assembly comprising:
a qubit configured to represent each one of two states,
one or more electrodes positioned so as to provide one or more electrical fields to the qubit,
a conditioning storage element positioned within a distance of 200 nm from the qubit, and
means for repeatedly supplying a predetermined signal to each of the one or more electrodes so that:
   a) it brings the qubit to a first state or phase by the supplying means feeding the predetermined signal to each of the one or more electrodes while the conditioning storage element comprises a first number of charged particles, and
   b) it brings the qubit to a second state or phase by the supplying means feeding the predetermined signal to each of the one or more electrodes while the conditioning storage element comprises a second number of charged particles,
wherein the first and second numbers of charged particles are different numbers of charged particles and wherein the first and second states/phases are different states/phases.

In this context, a qubit may be a two-level quantum-mechanical system, the basic unit for quantum information. A qubit is configured to represent two states. A qubit may represent a coherent superposition of states and thus can be in an infinite number of possible superposition states. A state of a qubit is, when detected, collapsed into one of two states, such as a “0” or a “1” or a “spin-up” or a “spin-down”. A qubit may comprise at least one storage position for holding one or more charged particles. Other qubit types have multiple storage positions for each holding one or more charged particles.

The altering of the qubit may be a change of a state thereof or a manipulation of the state. One type of manipulation or altering is an initialization.

Initialization of a qubit, in this context, is the bringing of the qubit into a predetermined or known state, such as one of the two possible measurement outcomes, which the qubit, at least, is able to have. Clearly, initialization will depend on the type of qubit. Initialization of some multiple particle qubits, such as a singlet-triplet qubit may be obtained by providing a particular one of the particles with a predetermined spin and the other with the opposite spin.

Other types of manipulation would be relative changes. For example, a bit may be flipped. Then, the bit will obtain the opposite value relative to its former state. Other manipulations may be phase changes by which the bit changes the phase of the superposition state, preferably while maintaining the probability to find it in e.g. the ‘1’ state.

A storage element, in this context, is configured to receive and hold/store, perhaps only for a brief period of time, a charge, such as represented by one or more charged particles.

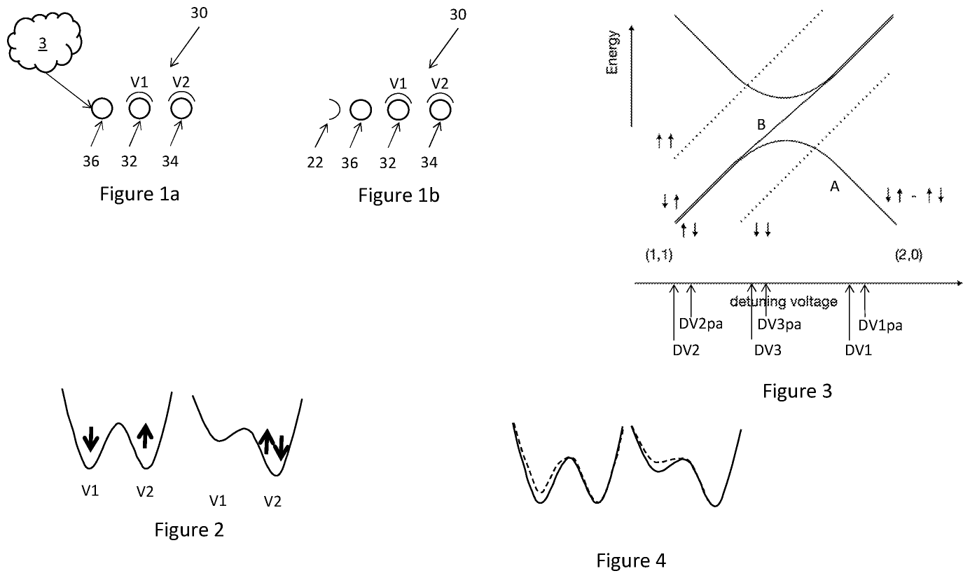

A preferred embodiment of the storage element relies on a semiconductor wafer structure with in-plane electron confinement into a planar two-dimensional electron gas (2DEG) at the material interface between a surface layer of higher band gap and the underlying substrate material. Structures of this type may be called hetero structures. Patterned surface gate electrodes are then used to deplete the 2DEG underneath. In addition, if the 2DEG structure is additionally depleted by gate electrodes confining the charge or charged particles in all directions, the structure may be called a quantum dot. At low temperatures (below 10 K), the number of electrons in each position or quantum dot is quantized and may be controlled by the gate electrodes (L and R; see FIG. 1 in Petta et. al. Science 309, 2180 (2005)). In a preferred embodiment, the storage element comprises a quantum dot. Quantum dots are well known and well behaved.

In this context, the charge is usually represented by one or more charged particles, where a charged particle could be an electron or a hole, such as in a semiconductor, an ion or other charged object, such as placed in electrostatic or optical traps. Preferably a single charged particle is provided. Clearly, positively and negatively charged particles will generate oppositely directed electrical fields.

The conditioning storage element is positioned within a distance of 200nm from the qubit. Then, a charge provided therein may provide an electrical field at the qubit. The electrical field may, together with the operation of the supplying means, influence the state of the qubit so that the presence or not of the charge may be used for determining the state in which the qubit will be subsequently. Thus, if the qubit manipulation is an initialization, the presence of the charge will determine in which state the qubit is initialized. Hence the term “conditioning”, as any contents of this storage element will affect or condition the qubit.

In this context, the “electrodes” are elements configured to provide a field or biasing on the qubit, such as on one or more charged particles of the qubit. The electrodes may emit a magnetic field, an optical field or an electrical field. The electrodes may be shaped in any desired manner and be made of any desired material, such as an electrical conductor. The electrodes may be positioned so as to affect the qubit in the manner required to manipulate it. A single particle or single storage position qubit may be affected or manipulated by altering a potential around the storage position, where e.g. a singlet-triplet qubit may be manipulated by affecting the potential of both storage positions.

It may be desired that the supplying means are operated in the same manner a number of times but where, if no charge is present, the qubit is altered in one manner or to one state or parameter, and, if a charge is present, the qubit is altered in another manner or to another state or parameter-or not at all.

In this context, the charge may represent any one of the qubit states or any desired manipulation/altering thereof and may have been derived from any type of information, such as quantum information from one or more quantum processor cores, see further below.

According to the invention, the conditioning storage element is capable of affecting a total charge within a distance of 200 nm of the qubit. Any charge will provide an electrical field which may affect the qubit, such as a spin-based qubit. Thus, in order to arrive at a sufficiently large difference between the situation where the charge is present and when no charge is present, it is desired that the addition of the charge is the only change in the charge of the surroundings within 200 nm, such as within 100 nm, such as within 50 nm of the qubit, such as a centre of the qubit. In this context, the distance between the qubit and the conditioning storage element may be between the conditioning storage element and a storage position of the qubit, such as between centres thereof or a lowest distance there between.

In one situation, the assembly comprises an additional storage element and a transferring element capable of transporting one or more charged particles between the additional storage element and the conditioning storage element, a distance of at least 200 nm existing between the additional storage element and the conditioning storage element. Thus, the charge is moved to the conditioning storage element from the additional storage element when the charge is desired in the conditioning storage element. If the charge is not desired in the conditioning storage element, it may be stored in the additional storage element, as this is sufficiently far from the qubit.

In that or another embodiment, the assembly comprises a reservoir and a transferring element capable of transporting one or more charged particles between the conditioning storage element and the reservoir. A reservoir may be positioned at any desired position, as a reservoir, especially if kept at a constant or at least substantially constant potential, will be connected to a source or potential from which it will receive a charge after having delivered a charge to the conditioning position. Thus, the reservoir will not itself experience a change in charge, so that the only change in charge within the 200 nm from the qubit is the charge added to the conditioning storage position.

An especially relevant type of qubit is one where the qubit comprises two or more storage locations each capable of holding a charged particle, such as a particle having a spin. In this situation, the conditioning storage position is preferably positioned closer to one of the storage locations than another of the storage locations.

Preferably, the supplying means is configured to receive a signal and provide the predetermined signal to the one or more electrodes. Naturally, the signal may cause the electrodes to output a corresponding field. In this context, the correspondence between the signal and the field may be a voltage, having a sign/polarity and/or a size, of the signal defining or determining a size and/or direction of the field. The supplying means may comprise one or more coils, electrodes or electrically conducting elements provided vis-à-vis the qubit to enable the signal to define the desired field. The field may be used for altering of manipulating the qubit, such as a state thereof, a phase thereof, a charge thereof, a spin thereof or the like.

It may be desired, when the qubit has two storage positions, that the supplying means comprises a generating means for providing a first potential at the first storage element, a second potential at the second storage element and optionally also a central potential at a position between the first and second storage elements. Clearly, the supplying means may be configured to vary or control each of the first, second and optional central potentials independently of the other(s). Thus, the supplying means may receive multiple signals, if a signal defines a single potential.

Then, the conditioning storage element will, when holding a charge, generate a first field strength at the first storage element and a second field strength at the second storage element. When the conditioning storage element is positioned closer to one of the storage positions than the other, the first and second field strengths will be different from each other. This may be preferred.

Clearly, the supplying means may be configured to perform different types of alterations, adaptations, manipulations or the like of the qubit. In one situation, the supplying means are configured to alter a spin direction of the qubit, such as a bit-flip. In another situation, the supplying means are configured to alter a phase of the qubit. Combinations of such alterings or manipulations may be desired. In yet another situation, the supplying means are not configured to perform relative alterations but an absolute altering, such as to initialize the qubit to a desired state/phase/spin direction.

Below, a manner of initializing a qubit of the two-storage-position-type is described. In general, the qubit may have or change between two states, usually defined by the position and spin of two particles.

In the following we consider the states, in what is often called a singlet-triplet qubit, in which the particles are positioned in different storage positions and have opposite spin as the two qubit levels. These states can either carry a total spin of 0, which is called the singlet state(S), or a total spin of 1, which is called the triplet state (TO). This is a commonly used qubit basis and more information can be found in [Levy2002, Petta2005, Hanson2007, Shulman2012,Maune2012, Wu2014].

[Levy2002] Universal Quantum Computation with Spin-1/2 Pairs and Heisenberg Exchange, J. Levy, Phys. Rev. Lett. 89, 147902 (2002).

[Petta2005] Coherent Manipulation of Coupled Electron Spins in Semiconductor Quantum Dots, J. R. Petta, A. C. Johnson, J. M. Taylor, E. A. Laird, A. Yacoby, M. D. Lukin, C. M. Marcus, M. P. Hanson, and A. C. Gossard, Science 309, 2180-2184 (2005).

[Hanson2007] Spins in few-electron quantum dots, R. Hanson, L. P. Kouwenhoven, J. R. Petta, S. Tarucha, and L. M. K. Vandersypen, Rev. Mod. Phys. 79, 1217 (2007).

[Shulman2012] Demonstration of Entanglement of Electrostatically Coupled Singlet-Triplet Qubits, M. D. Shulman, O. E. Dial, S. P. Harvey, H. Bluhm, V. Umansky, and A. Yacoby, Science 336, 202-205 (2012).

[Maune2012] Coherent singlet-triplet oscillations in a silicon-based double quantum dot, B. M. Maune, M. G. Borselli, B. Huang, T. D. Ladd, P. W. Deelman, K. S. Holabird, A. A. Kiselev, I. Alvarado-Rodriguez, R. S. Ross, A. E. Schmitz, M. Sokolich, C. A. Watson, M. F. Gyure, and A. T. Hunter, Nature 481, 344-347 (2012).

[Wu2014] Two-axis control of a singlet-triplet qubit with an integrated micromagnet, X. Wu, D. R. Ward, J. R. Prance, D. Kim, J. K. Gamble, R. T. Mohr, Z. Shi, D. E. Savage, M. G. Lagally, M. Friesen, S. N. Coppersmith, and M. A. Eriksson, PNAS 111, 11938-11942 (2014).

These references are hereby incorporated herein by their reference.

Then, initialization could be one where the particles are provided in a predetermined one of these two spin states, as described in [Petta2005].

When particles are provided in the two storage positions, they firstly need to have oppositely directed spins. The easiest manner of obtaining this is to force both particles into a single storage position, where the lowest energy state then will be the particles having oppositely directed spin (singlet state S). This will automatically happen over time. This may be obtained by elevating the potential of one storage position relative to the other storage position so that the particle in the elevated storage position travels to the other storage position. This travelling may comprise a tunnelling through a central potential if the elevated potential does not exceed the central potential, which it may or may not. Alternatively, one particle may be exchanged by another particle with opposite spin from a reservoir. Now the particles will move to, or be in, the lowest energy state of opposite spins.

Then, the two particles are separated to again have one in each storage element. This may be achieved by lowering the elevated potential to again form two wells with equal or at least more potentials. During this process, the singlet spin state preferably is maintained, which is achieved by choosing the correct speed with which the potentials are adjusted. This adjustment speed might be non-linear. This procedure initializes the singlet state of the qubit.

To alter the qubit to the triplet spin state, the potential of one storage position is again increased compared to the other storage position, this time to allow the particles to form a superposition of having both particles in one storage position and having each particle in a separate storage position. Under these conditions the exchange interaction between the particles, which is related to the tunnel rate through the central potential, rotates the qubit from a singlet to a triplet state and vice versa. To initialize the triplet state, the particles are kept in this superposition for a predetermined period of time, in which the two particle spin state has changed to the triplet state, where after the potentials are restored to the (at least substantially) equal potential wells to contain the particles in the respective storage positions.

Thus, the qubit is then initialized in the triplet spin state using this procedure.

Clearly, what is relevant in the above is the relative potentials, so that lowering one potential or increasing the other will have the same effect.

However, it may be desired that the latter swapping or altering step is not performed, such as when the initial spin directions in the storage positions was the desired initialization state.

Clearly, the latter step may be omitted, but it is desired that the only difference between the initialization into the two states is the presence or not of the charge in the conditioning storage element, so completely omitting that step is not desired.

Instead, the conditioning storage element is provided at a position where the electrical field of a charge therein, when present, is larger at one of the two storage elements than the other. Thus, when a charge is present, the electrical field thereof will affect the energy or potential at one of the storage positions more than the other. It may be desired that the conditioning storage element is closer to one of the storage elements of the qubit than the or each other storage element of the qubit.

The conditioning storage element may then be positioned, relative to the first and second storage positions, so that, when the potential of the one storage position is increased, a charge in the conditioning storage element will prevent or modify/shift the superposition. The presence of a charge in the conditioning storage element will then also prevent or slow down the rotation to the triplet state in the predetermined time. The presence of the charge preferably changes the superposition to a degree where no significant rotation away from the singlet state occurs in the predetermined time when the charge is present in the conditioning storage position. The supplying means and its operation need not be changed, such as by changing potentials, as defined by e.g. electrodes or other means, of the first and second storage positions, when no charge is present or when charge is present. However, the presence of the charge may alter the total potential of a storage position even without changing the operation of the supplying means, such as electrodes, signals or other means.

Thus, the presence of the charge may lower the potential at one or both of the storage positions, and/or increase the potential at one or both of the storage positions, as long as it changes the two potentials at the two storage positions in a different way. Providing different potentials at the storage positions is often called detuning the qubit.

Naturally, this may be reversed so that the super position is only seen, when the one potential is increased, when a particle is present in the conditioning storage position. Thus, when the same potential is increased but there is no charge in the conditioning storage position, the potentials of the qubit do not allow, or hamper or slow down, the super position and thus the altering between the states of the qubit.

Another type of qubit would have a single storage position and may be represented or comprise a single charged particle. This qubit may have two states at different energy levels, where the qubit may alter between these states. Again, the electrodes or the fields of the supplying means may be used for altering the state of the qubit. Then, the presence of a charge in the conditioning storage element would generate a field which would be present (but only if the charge is there) at the position of the single storage position and thus alter the energy level or potential at the single storage position. It could also alter the difference in energy between the qubit levels. In this manner, the field from the charge in the conditioning storage element may prevent-or facilitate-the qubit state altering desired when the supplying means feed the predetermined signals or fields to the single storage position. In this type of situation, it may be desired that the storage element is made of a material exhibiting spin-orbit coupling.

In this context, the charge in the conditioning storage element, which now defines the initialization state, may represent any type of information and may be received from any source. The charge may represent the readout of quantum information from one or more qubits or quantum processor cores, see further below. Multiple types of quantum processor cores exist, some of which operate on or output a charge and others a spin. Often, a resulting spin is converted into a charge for easier and more robust read-out.

In one situation, the charge stems from a former read-out of the same qubit, so that this read-out may be a memory function using this historic read-out to determine the initialization of this, later, operation of the qubit. Reading-out of a qubit is a standard procedure. The qubit state at read-out often will be a superposition of its basic states, often a “0” or “1” or “spin-up” or “spin-down”, where the reading-out or the detection will collapse this superposition into one of these states. That state may then be converted into one of the two states of “charge present” or “charge not present” which may determine whether the charge is fed to the conditioning storage element or not.

In another situation, the assembly further comprises:
one or more additional qubits,
means for converting a state of each additional qubit into a charge,
a logical circuit configured to receive the charge(s) from the converting means and provide the charge(s) to the storage element.

Then, each additional qubit, potentially in addition to the actual qubit, may be read-out or detected to arrive at a “charge” or “no charge” for each qubit. These charges may then be combined into a resulting charge (which may be no charge) which may be fed to the conditioning storage element.

The combination of the charges is performed in a logical circuit. This circuit may embody any logical function between the charges from the qubits. A charge may be taken as e.g. a “true” or “1” and no charge as a “false” or “0”, so that a standard Boolean function may be defined and performed. Below, manners of embodying a Boolean function even at temperatures below 1K are described.

A second aspect of the invention relates to a system comprising a plurality of assemblies as described above of the type where the supplying means are configured to receive a signal and provide a field to the qubit. In this aspect, the system further comprises a signal input for receiving an input signal and a distributing element configured to feed the predetermined signal to all supplying means.

Naturally, all aspects, embodiments, situations and considerations may be exchanged freely between the aspects of the invention. Thus, the present assemblies may be as described above.

As the altering of the qubits is determined primarily or entirely by the presence or not of the charge, the same signal may be fed to all qubits or supplying means, where charges are then provided to the qubits desired altered—or those not desired altered. Feeding the same signal to all qubits or supplying means has the advantage that a single signal may be provided instead of one signal per qubit.

The system may comprise any number of assemblies, such as 2, 4, 9, 16, 25, 36, 100, 1000 or more.

The distributing means may be embodied in any desired manner, such as electrically conducting portions of a substrate in or on which the qubits and/or supplying means are provided. It may be desired that a path length is at least substantially the same from the signal input to the supplying means, as timing may be of essence in the system. The signal input may be an electrically conducting portion of the system, such as a connector or wire configured to transport the signal.

In one embodiment, the system further comprises a feeding element configured to feed a charge to the conditioning storage element(s) of one or more predetermined qubits of the qubits. The feeding element may be a common element or a number of distributed elements. The feeding element preferably is configured to be controlled so that the providing of a charge may be controlled individually for each conditioning storage element. The feeding element may comprise one or more of the above reservoirs and/or one or more of the above additional storage elements. The controlling of a transport or feeding of a charge may be obtained by suitable controlling of e.g. fields, potentials or electrodes as is known.

As mentioned above, the supplying means may perform an altering of a state, phase, spin, charge or the like of a qubit. Also, above, initialization is described, but other reasons exist for wishing to alter a state or the like of a qubit.

One important example is error correction or fault resistance of qubits or a quantum processor having one or more qubits.

A qubit, however, may unintendedly arrive at an erroneous state, spin, phase, charge or the like for any number of reasons.

To address this, systems are devised in which the same operation is performed not by a single qubit but a plurality of qubits all intended to perform the same operation and thus be in the same state. Then, when a qubit arrives at an erroneous state, this may be realized by comparing that state to the state of the other qubits. From this comparison, an erroneous qubit may be identified and then corrected or altered.

Multiple types of error may be possible, where the comparisons then relate not only to the identification of erroneous qubits but also which error or alteration is seen or required.

The altering of a qubit, such as the above two-storage-position qubit, may be an altering of a phase thereof and/or a spin/bit flip thereof—often called a Z error or an X error.

The reading-out of the qubits and the identification of the erroneous qubit(s) as well as the determination of the required altering may be as usual. The altering of the qubit(s) may, however, be simpler than a separate controlling of all signals and potentials to each qubit.

Then, the system may further comprise generating elements configured to:
a. generate information from a state of each of the qubits,
b. identify one or more first qubits of the qubits and
c. control the feeding element to provide a charge in the conditioning storage element(s) of the identified first qubit(s).

The information may be derived in a manner so that the individual qubit does not lose or alter its state. For example, the use of the so-called CNOT circuits enables deriving information relative to a state of a qubit or a difference of states of multiple qubits, without altering the states of the qubits. This has the advantage that an altering to be performed is relative to a present state of the qubit. The altering may be a relative altering, such as a bit-flip or a rotation of a spin. An alternative would be to initialize that qubit in the state in which it was desired, which would be an absolute altering to a particular state irrespective of the former state.

The identified first qubits may be qubits which are desired altered, altered in a particular manner or not desired altered, depending on whether the presence of a charge in the conditioning storage position of the pertaining assembly permits or prevents altering.

The feeding element then feeds charges to the pertaining assemblies. Preferably, this step (step c.) is performed before or when a first received signal is fed to the supplying means, so that the charges are provided when the signal is distributed. The first received signal may be derived or provided to alter the first qubits (or the remaining qubits) in a particular manner in which the first qubits differ from one or more of the remaining qubits (or vice versa). It may be desired that the result of the first signal is to have a larger number of the qubits have the same state, phase, spin, charge or the like.

In one embodiment, the generating means are configured to:
subsequent to step b. identify one or more second qubits of the qubits and
before or after step c. control the feeding element to provide a charge in the conditioning storage element(s) of the identified second qubit(s).

As mentioned above, qubits may have one or more of a plurality of erroneous states so that the first qubits may be qubits having one error or erroneous state, such as a state with a phase error, and the second qubits are qubits having another erroneous state, such as a state requiring a bit/spin flip. Clearly, qubits may have both errors and thus belong to both the first and second qubits.

Then, the feeding element preferably is configured to provide the charge(s) to the identified second qubit(s) before or when a second received signal is fed to the supplying means.

The second qubits (or the qubits not being the second cubits) may be qubits identified with an error different from that of the first qubits (or the qubits not being the first qubits), so that the second signal is a signal correcting or altering another error. Again, the intended purpose is to, after the providing of the second signal, have more qubits in the same state.

The two alterations may require the same, different or overlapping means. One alteration may require the providing of a varying electrical field in the qubit, where another may require the providing of a magnetic field. One alteration may require a combination of an electrical field and a magnetic field. The supplying means thus may comprise means required for each alteration of the qubit.

Thus, error correction may be performed when all the qubits are intended to be operated in the same manner. Thus, the qubits may be initialized, such as by the above-described method, and the errors detected and corrected, where after operation may proceed with corrected qubits.

In this context, the identification of the first/second qubits may be performed in the usual manner, e.g. by feeding the information from the states of the qubits to a standard computer, then forming part of the generating means, which would normally be at room temperature, thus requiring the providing of a large number of cables or connections from the qubits to room temperature.

However, an interesting alternative exists in which the identification of the first/second qubits is made locally or at least at a lowered temperature, such as at no more than 100K, such as no more than 50K, such as no more than 10K, such as no more than 1K.

Information processing is possible at these low temperatures, whereby no information from the qubits need be fed to higher temperatures and at least not to room temperature when a local or colder processor is available.

In one situation, a processor may be based on circuits or gates based on storage elements where the flow of charges to/from such elements is controlled by the presence or not of charges in another storage element.

For example, a NOT gate or circuit may comprise:
an input storage element configured to receive one or more charged particles,
a first operator element comprising:
a first operator storage element,
a first source of charged particles configured to feed charged particles to the first operator storage element,
a first controlling means configured to control the first source to:
feed a first number of charged particles to the first operator storage element if the input storage element holds fewer charged particles than a first threshold number of charged particles, the first number of particles being at or above a second threshold number of charged particles and
feed a second number of charged particles to the first operator storage element if the input storage element holds more charged particles than the first threshold number of charged particles, the second number of particles being below the second threshold number of charged particles.

Then, this circuit may be configured to copy charges or information represented by charges by further comprising a second operator element comprising:
a second operator storage element,
a second source of charged particles configured to feed charged particles to the second operator
storage element,
a second controlling means configured to control the source to:
feed a third number of charged particles to the second operator storage element if the first operator storage element holds fewer charged particles than the second threshold number of charged particles, the third number of particles being at or above a third threshold number of charged particles and
feed a fourth number of charged particles to the second operator storage element if the first operator storage element holds more charged particles than the second threshold number of charged particles, the fourth number of particles being below the third threshold number of charged particles.

A two-input logical NOR gate or circuit may comprise:
a first input storage element configured to receive one or more charged particles,
a second input storage element configured to receive one or more charged particles,
a first operator element comprising:
a first operator storage element,
a first source of charged particles configured to feed charged particles to the first operator storage element,
a first controlling means configured to control the first source to:
feed a first number of charged particles to the first operator storage element if:
the first input storage element holds fewer charged particles than a first threshold number of charged particles and
the second input storage element holds fewer charged particles than a second threshold number of charged particles, the first number of particles being at or above a third threshold number of charged particles and
feed a second number of charged particles to the first operator storage element if:
the first input storage element holds more charged particles than the first threshold number of charged particles, or
the second input storage element holds more charged particles than the second threshold number of charged particles, the second number of particles being below the third threshold number of charged particles.

A two-input logical NAND gate or circuit may comprise:
a first input storage element configured to receive one or more charged particles,
a second input storage element configured to receive one or more charged particles,
a first operator element comprising:
a first operator storage element,
a first source of charged particles configured to feed charged particles to the first operator storage element,
a first controlling means configured to control the first source to:
feed a second number of charged particles to the first operator storage element if the first input storage element holds more charged particles than a first threshold number of charged particles and the second input storage element holds more charged particles than a second threshold number of charged particles, the second number of particles being below a third threshold number of charged particles and
feed a first number of charged particles to the first operator storage element if the first input storage element holds less charged particles than the first threshold number of charged particles and/or the second input storage element holds less charged particles than the second threshold number of charged particles, the first number of particles being at or above the third threshold number of charged particles.

From these circuits or gates, any other Boolean operator may be embodied and any circuit used for e.g. the above error correction may be derived, when the states of the qubits or relations between the qubits are represented as one or more charged particles and uses as inputs to a circuit or network generated by such gates or circuits.

These gates or circuits are described in Applicant's co-pending application filed on even date and with the title “CIRCUIT FOR TRANSPORTING CHARGED PARTICLES”, which is hereby incorporated herein in its entirety by reference.

Another aspect of the invention relates to a method of operating an assembly, such as a quantum computer or a part thereof, comprising:
a qubit,
one or more electrodes positioned so as to provide one or more electrical fields to the qubit,
means for supplying a signal to each of the one or more electrodes, and
a conditioning storage element positioned within a distance of 200 nm from the qubit,
the method comprising the steps of:
bringing the qubit to a first state or phase by the supplying means feeding a predetermined signal to each of the one or more electrodes while the conditioning storage element comprises a first number of charged particles, and
bringing the qubit to a second state or phase by the supplying means feeding the predetermined signal to each of the one or more electrodes while the conditioning storage element comprises a second number of charged particles,
wherein the first and second numbers of charged particles are different numbers of charged particles and wherein the first and second states/phases are different states/phases.

Clearly, any considerations, embodiments, situations or the like given above are equally relevant for this aspect of the invention.

Thus, the qubit and conditioning storage element may be as described above.

The effect of the presence or not of the charge is as described above where the conditioning storage element, within 200 nm of the qubit, may be the only element allowed to alter its total charge.

As described, the charge may be provided from a reservoir and/or from a storage position sufficiently far from the qubit.

As described above, the altering may be a step of altering a state, phase, spin, and/or charge of the qubit either when the charge is provided in the conditioning storage element or when no charge is provided in the conditioning storage element.

As mentioned, the altering may be a relative altering, such as for use in error correction, or an absolute altering, which may also be used for error correction but which is also useful in initialization of a qubit.

As described above, altering, such as the initializing, may comprise the providing of the same altering, such as the same altering signals, where the difference in the actual state obtained in the altering is defined only by the presence or not of the charge.

As described, an interesting type of qubit comprises a first and a second storage element, and potentially additional storage elements, each configured to hold a particle, or one or more particles, having a spin. Then, the supplying means may comprise a generating means for providing a first potential at the first storage element, a second potential at the second storage element and optionally also a central potential at a position between the first and second storage elements.

Then, i may be desired that:
the bringing of the qubit to the first state comprises providing a first potential at the first storage element, a second potential at the second storage element and a central potential at a position between the first and second storage elements, and
the first number of charged particles in the conditioning storage element generate a first field strength at the first storage element and a second field strength at the second storage element, the first and second field strengths being different from each other.

It may be preferred that the conditioning storage element not holding a charge generates a first field strength at the first storage element and a second field strength at the second storage element, the first and second field strengths being at least substantially identical, such as zero.

In general, it may be desired that an altering is performed, when there is no charge in the storage position, by:
a) providing a first signal to the generating means, causing the generating means to alter one or more of the central potential and the first and second potentials to have one of the first and second potentials lower than the other to provide both particles in the lower potential storage position,
b) providing a second signal to the generating means causing the generating means to have the central potential larger than both the first potential and the second potential, generating two potential wells, and
c) providing a third signal to the generating means causing the generating means to alter the first and second potentials to potentials causing the particles to get into a superposition of being both in the same potential well and being each in a separate potential well, before providing a fourth signal to the generating means causing the generating means to have the central potential larger than both the first potential and the second potential, generating two potential wells, such as the second signal as provided in b).

This may be a standard initialization of e.g. a singlet-triplet spin qubit.

In this context, the intention with step a) is to provide both particles in one storage position. In this case, as explained further above, the spins of the particles will align to anti parallel directions to form an asymmetric spin-state with a total spin of 0 to arrive at a lower energy state, which is called the singlet state.

The providing of the particles in one storage position may be obtained by having the potential of that storage position lower than the other storage position and the central potential. It is noted that a particle may tunnel through the central potential so this potential need not be lower than the potential of the other storage position.

It may be desired that in step a) a difference between the central potential and the potential of the highest potential storage position is within 10% of the absolute value of the largest of the potentials of the storage positions and the central potential. However, this potential difference will be highly dependent on the fabrication method, materials and the like. In that or another situation, it may be desired that the difference between the central potential and the potential of the highest potential storage position generates a potential energy of more than 0.1 eV. Again, this is highly dependent on the choice of manufacturing method and materials.

In that or another situation, the central potential and the potential of the highest potential storage position may be selected so that both the tunnelling of the particles to the lower potential well as well as the relaxation into the lower energy state will occur within a specific time, such as within 10 μs, 1 μs, 100 ns. It may instead be desired to allow one of the particles to move into a reservoir and where another particle, with the other spin, travels from the reservoir into the qubit.

The intention of step b) then may be to create two separate storage positions. This may be obtained by ensuring that the central potential is higher than the first and second potentials.

Between step b) and c) an intermediate step may be performed of separating the two particles to have one in each storage position. It may be desired to, during the initial portion of step c) to raise the potential of the storage position holding the two particles to allow one particle to move across or over the central potential and into the other storage position. Alternatively, also the potential of the higher potential storage position can be lowered, or a combination of the raising and lowering of the respective potentials can be applied. After this transition, it may be desired to lower the potentials of one or both of the storage positions or to raise the central potential to ensure that the particles stay in the respective storage positions.

During the intermediate step it is desired that the particles maintain their spin. In the situation where the particles are separated to have one in each storage position and with a finite external magnetic field, the lowest energy state consists of both spins being parallel, aligned with the magnetic field. To avoid going into this state during the intermediate step the change in potentials should also be faster than the spin-flip or relaxation rate.

After step b) or the intermediate step, an initialization may be obtained in which the spin direction in the two storage positions are anti parallel and where the total spin is 0. This state, the singlet state, may be called a “0” state of the qubit.

If initialization is desired to the opposite situation, the triplet state, step c) is performed.

In step c), it is desired to alter the first and/or second potentials in a manner so that the particles in the storage positions obtain a superposition of both particles being in a single potential well and the two particles being in separate potential wells. In this superposition the qubit is rotated over time from the singlet state to the triplet state, and vice versa, driven by the exchange interaction between the two particles (see e.g. [Petta2005]). The speed of this qubit rotation depends on the exchange interaction strength, which increases by raising the tunnel rate between the two potential wells or by raising the probability amplitude of having both particles in the same potential well in the superposition state. The tunnel rate can be controlled by tuning the central potential, while the probability amplitude of having both particles in the same potential well can be controlled by tilting the potential landscape, i.e. by the difference in the potentials at the first and second storage positions. Step d) ends by aiming to again lock the particles into the respective storage positions, such as after exactly one qubit rotation (180 degrees), to arrive at an initialization with the triplet spin state in the storage locations, such as a “1” state of the qubit.

As mentioned above, it may be desired that step c) comprises maintaining the first and second potentials for a predetermined period of time before a fourth signal is fed, returning to the “separated” position, such as by again providing the second signal, also provided in b), so that the state of the qubit has time to change.

At the end of step c) the particles are again provided and locked or contained in the respective storage locations by ensuring that the first and second potentials are lower than the central potential. It may be desired that the first and second potentials in this situation are equal.

Thus, the first, second and usually also the central potentials are controlled by feeding the signals to the generating means. When no charge is present in the storage element, the generating means provides the potentials described.

However, when a charge is present in the storage element, the resulting potentials in the storage positions and possibly also the position between the storage positions will be altered.

As mentioned above, the procedure need not be an initialization. Thus, the first step of providing the particles in the lowest energy state need not be performed. Instead, the potentials of the qubit may be brought to the superposed state to allow the states to rotate in a desired manner and during a desired period of time allowing the qubit to alter its state in the desired manner. This altering may be relative to an initial state of the qubit.

However, it is desired to, when the charge is provided in the storage position, to:
initially provide the first signal to the generating means,
then, provide the second signal to the generating means,
then, provide the third signal to the generating means, and
finally provide the fourth signal to the generating means,
where the field from the charge in the conditioning storage position operates to alter the difference in potential between the first and second storage elements., such that, for example, the electric field from the charge in the conditioning storage element tilts the total potential towards the point where the potentials of the first and second storage positions are equal.

In step c) the lack of presence of the charge reduces the probability amplitude of having both particles in the same potential well, thereby reducing the rotation speed of the qubit due to a lower exchange interaction strength. With a significant change in probability amplitude, the qubit state might not make any significant rotation within the prescribed time, therefore staying in the singlet, or ‘0’, state. When the charge is present in the conditioning storage element, the qubit will make a full rotation to the triplet, or ‘1’, state in the same prescribed time.

As described above, the qubit may alternatively be a single storage position qubit having two states at different energy levels. Any charge in the conditioning storage element will add a contribution to the energy level or potential at the single storage position. The supplying means may supply fields or signals causing the qubit to alter state when no charge is present in the conditioning storage element or only when a charge is present in the conditioning storage element.

Then, even when the supplying means is operated in the same manner, the resulting initialization or altering of the qubit is different, caused merely due to the presence or not of the charge in the conditioning storage element.

Clearly, this process may be reversed so that the signals to the supplying means generate, together with a particle in the conditioning storage element, the above functionality and relative potentials, so that the initialization including the swapping of the spins takes place when the particle is in the conditioning storage element. Then, when no particle is present in the conditioning storage element, the lack of the corresponding electrical field will alter the resulting potentials in the qubit so that the rotation is not seen or is not seen with that speed or with a reduced probability.

Thus, the operation of the conditioning storage element is again to hold a charge affecting the initialization or altering. In this context, it is clear that the conditioning storage element may be positioned, vis-à-vis the two storage positions, in different positions. The position of the conditioning storage element will determine the electrical field at the two storage positions and thus how to operate the supplying means in order to have the desired effect.

As described above, the charge in or for the storage element may represent any data or information and may stem from an earlier read-out or result of the same qubit or another qubit. In fact, the method may further comprise the steps of:
for each of one or more additional qubits, generating a charge from a state of the additional qubit,
deriving, from the generated charge(s), a charge and providing the charge in the conditioning storage element.

In that manner, the qubit in question may be initialized based on the output or result of a number of qubits, so that serial processing may be obtained.

A fourth aspect of the invention, similar to the second aspect, relates to a method of operating a system comprising a plurality of assemblies in which the altering is performed using an electrical signal, the method comprising receiving an input signal and forwarding the predetermined signal to all supplying means.

Then, the method may further comprise the step of feeding a charge to the conditioning storage element(s) of one or more predetermined qubits of the qubits, so that the predetermined qubits are altered or so that the remaining qubits are altered.

As mentioned above, error correction is another manner of utilizing the altering and in particular the altering using a central or common signal.

In one embodiment, the method further comprises the steps of:
a. generating information from a state of each of the qubits,
b. identifying one or more first qubits of the qubits and
c. feeding a charge to the conditioning storage element(s) of the identified first qubit(s).

As described above, the first qubits may be qubits which have a state/spin/phase/charge different from other qubits or different from a majority of the qubits. Alternatively, the first qubits may be the majority of the qubits having the same state or the like.

The first qubits or the remaining qubits may be identified as qubits requiring a particular altering, such as a change in state, charge, spin, phase or the like, and a first signal may be identified or derived which may correct this.

Then, the feeding step preferably comprises feeding the charges (step c.) when or before a first received signal is fed to the supplying means. Then, the charges, or alternatively the absence thereof, will ensure that the altering provided by the first signal, is performed to the qubits intended altered in that manner.

Again, the first signal may be fed to all qubits where the charges then ensure that only the intended qubits are altered.

In addition, the method may further comprise the steps of:
subsequent to step b. identifying one or more second qubits of the qubits and
before or after step c. feeding a charge in the conditioning storage element(s) of the identified second qubit(s).

The second qubits, or the remaining qubits, may be qubits requiring another alteration, such as a change in state/spin/charge/phase or the like. This change or altering may be effectuated by providing a second signal to the pertaining qubits so that the method may comprise feeding the charge(s) to the identified second qubit(s) before or when a second received signal is fed to the supplying means. So that they are present when the second signal is provided and the pertaining altering performed.

In the following, preferred embodiments will be described with reference to the drawing, wherein:

FIGS. 1a and 1b illustrate a two storage position qubit and a conditioning storage element,

FIG. 2 illustrates different potential setups during initialization of a two storage position spin qubit,

FIG. 3 illustrates the relevant energy diagram of the two particle spin states,

FIG. 4 illustrates the setups of FIG. 2 now with a charge offsetting the potentials,

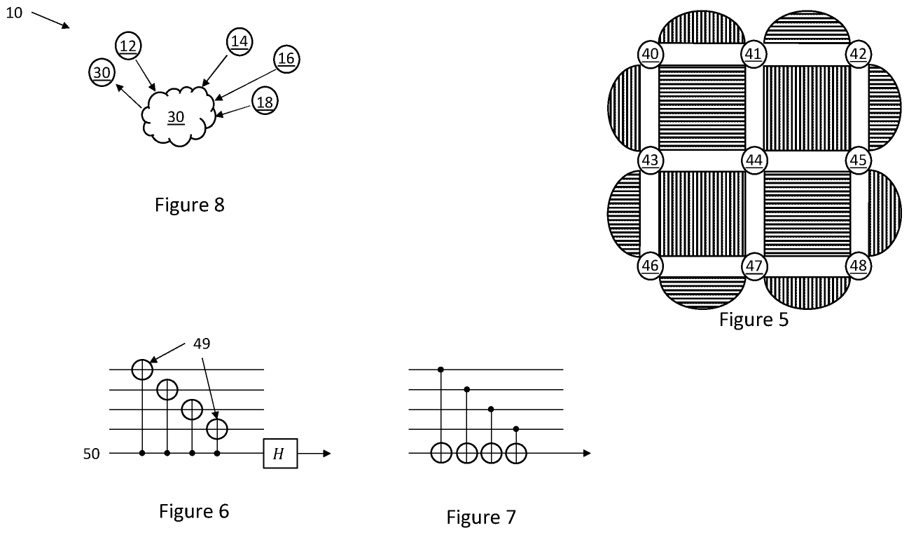

FIG. 5 illustrates error handling in qubits,

FIGS. 6 and 7 illustrates error handling of qubits, and

FIG. 8 illustrates the use of the states of multiple qubits to determine the desired state of a qubit.

In FIGS. 1a and 1b, a dual spin particle qubit 30, such as a single-triplet qubit is seen having a first storage element 32 for holding a first particle with a spin and a second storage element 34 also for holding a, second, particle with a spin. In addition, electrodes or the like, V1 and V2, are provided for providing separate potentials in the storage elements. Additional electrodes or the like may be provided for also generating a desired potential between the storage elements 32, 34. Also, a conditioning storage element 36 is provided.

Standard singlet triplet qubits comprise corresponding storage elements and electrodes.

In FIG. 2, the potential landscape of the two storage elements and their surroundings is illustrated for two situations. The particles are represented by arrows illustrating their spin directions.

To the left in FIG. 2, the potentials V1 and V2 are of the same magnitude, whereas a potential between the storage elements is higher, so that two potential wells are defined, where one particle exists in each.

The height and width of the potential bump or barrier between the storage elements will determine whether the particles are able to, or rather the probability with which the particles, tunnel through the bump/barrier to the other well.

To the right, the potential V1 has been increased so that the well is quite shallow, which may result in the particle formerly in that well having travelled to the potential V2, which is lower. This well now comprises two particles.

The degree of difference between the potentials V1 and V2 may be called a detuning or detuning voltage.

Returning to the singlet-triplet qubit, initialization thereof may be explained with reference to FIG. 3 illustrating the relevant energy diagram of the two particle spin states (see also e.g. [Petta2005]). In FIG. 3, the x axis represents a detuning voltage. Detuning refers to the non-symmetricallity of the potential landscape and where a high detuning corresponds to one well being shallow, while the other well is deep, and a low detuning corresponds to equal wells for holding the particles. Referring to FIG. 2, the left illustration is a potential landscape with a low detuning, where the illustration to the right has a high detuning.

In FIG. 3, the y-axis represents the energy of the two-particle spin states.

In FIG. 3, the curved line A represents the two-particle singlet state, which is the lowest energy state when both particles are located in the same potential well (right side of the figure) and the second lowest energy state when both particles are in separate potential wells. The curvature shows the superposition of having both particles in the same potential well or having both particles in separate potential wells.

The straight line, B, represents the two-particle triplet spin state, with both particles in separate potential wells. The triplet spin state with both particles in the same potential well is much higher in energy and of no consideration in this system and falls outside the energy scale in this figure.

Initialization is performed by providing a particle in each storage element and increasing the detuning voltage, to a value DV1pak, so that a situation as seen to the right in FIG. 2 is obtained. The advantage of this situation is that the two particles, to arrive at the lowest energy, will have oppositely directed spins and form a state of a total 0 spin, the singlet state. Thus, opposing spins are obtained.

Decreasing the detuning, to the value DV2pa or a value similar to that, by moving towards the landscape illustrated to the left in FIG. 2, or a similar landscape, will make one particle prefer to travel to the other storage element, while the spins are maintained by accurately controlling the speed with which the detuning is decreased.

To change the spin state of the two particles to the triplet state, the detuning may be increased to a value DV3pa at or close to the top of the A curve, where one of the wells is slightly more shallow so that the storage elements may comprise a superposition of a state in which one particle is in each storage element and a state in which both particles are in one storage element. Then, automatically, the exchange interaction between the particles will rotate the spin state from the singlet state of curve A to the triplet state of curve B, and vice versa. After a given time, depending on the exchange interaction strength, the spin state will have completed exactly the rotation to the triplet state, where after the detuning voltage may again be reduced to arrive at a potential landscape situation as seen in FIG. 2, to the left, but with the two-particle spin state changed to the triplet state.

It is noted that the detuning voltage relates to the tilting of the potential landscape, which could be reached by raising the first potential, lowering the second potential, or a combination of both.

It is again seen that initialization to one state is performed differently than initialization to the other state. Also, it is seen that the initialization is performed by controlling the means V1, V2 and the qubit rotation at position DV3pa.

According to the invention, a charge in the storage element 36 may be used for affecting the potential landscape of the two storage elements and thereby affect the initialization. In FIG. 4, the two situations of FIG. 2 are illustrated together with, in broken lines, the situation when a charge of the same sign as that of the storage element 32 is present in storage element 36. In this situation, the well at the storage element 32 is effectively more shallow, as the charge in the storage element 36 acts to repel the particle in storage element 32. This effectively makes the qubit act as with an increased detuning voltage.

Then, this may be taken advantage of by not using the values DV1/2/3pa but instead the values DV1/2/3 which will provide the desired effect when there is a charge in storage element 36. Then, the corrected detuning voltages DV1/2/3 will effectively, combined with the contribution from the charge, give the desired detuning corresponding to the values DV1pa, DV2pa and DV3pa. In this manner, the detuning voltages described above may be reduced while still generating the correct initialization when a charge is present in storage element 36.

The initialization may be as described above, using the voltages DV1/2/3 when the charge is present in the storage element 36.

However, when no charge is present in storage element 36, the initialization using the same voltages, the detuning starts at a sufficiently high value to still define a potential landscape with a single, deep well and potentially a shallow or no other well. Then, again, the particles will be in one storage element and align their spins anti parallel in the singlet state. Reducing the detuning voltage still arrives at a situation where two sufficiently deep wells are seen for the particles to each occupy a separate storage element.

Then, now bringing the detuning voltage to the value DV3, this brings the potential landscape, due to the missing effect of the charge in storage element 36, so far from the top of the curve A that the exchange interaction will not bring the spin state of the particles to curve B and leading to no significant rotation of the two-particle spin state. Thus, bringing the qubit back to the state seen to the left in FIG. 2 will not have altered the spins of the qubit.

Thus, the presence of the charge in the storage element 36 now affects the initialization so that the presence of the charge defines initialization to one state and the absence thereof defines initialization into the other state.

It is noted that also away from the peak position of the A curve, a superposition will be seen and a slight rotation will result. However, when the DV3 voltage is sufficiently distanced from the optimum DV3pa and as the period of time during which this voltage is maintained is optimized for the optimum DV3pa, the rotation seen at DV3 during the same period of time will be insignificant.

It is thus seen that the same signal, comprising the voltages DV1/2/3 in a desired order and with desired time periods or time durations, may be fed to the qubit where the presence of the charge will then ultimately decide whether the state of the qubit is altered or not.

It is noted that the effect illustrated in FIG. 4 will be the largest if the situation where “no charge is present” at least means that no charge is too close. It may be acceptable that a charge is present, if it is more than 200 nm from the qubit 30, as a charged particle at that distance will have a negligible field at the qubit. This is the situation illustrated in figure la, where the charge is provided by a source 3, such as another qubit or storage location sufficiently far from the qubit. Alternatively, as seen in FIG. 1b, the charged particle may be derived from a reservoir 22. When the reservoir maintains its potential before and after delivery of the charge, the presence of the reservoir will have no additional effect on the qubit. When the charge leaves the reservoir, another charge is provided to the reservoir from a position distant to the qubit (the element maintaining the potential of the reservoir).

The above procedure may be used for initializing the qubit in a desired state, where the same signal may be fed to the qubit and the charge may then determine the state. However, other manipulations of a qubit may be performed based on the same method.

In fact, the state in which it is desired to initialize the qubit 30 may then be determined in any desired manner. In one situation, as seen in FIG. 8, a system comprises not only the qubit 30 but also additional qubits 12, 14, 16, 18, the state or output of which may be used for determining the initialization state of the qubit 30. Also a former or earlier state of the qubit 30 may be used in that determination. Naturally, the states of the qubits may be transported to room temperature to have the determination performed in a standard computer, but it is possible to perform the determination locally or at a lower temperature, such as cryogenic temperature using e.g. a circuit as described below.

In quantum computing, error correction is important. Error correction often is based on parallel operation of a number of qubits and the comparison of the state of these qubits to detect and correct differences between such states.

In FIG. 4, an array of 9 qubits 40-48 is illustrated. The operation of these qubits preferably is identical so that in an ideal world, all qubits would be in the same state at all times. In the real world, this is not the case.

Thus, from time to time, the states of the qubits is read out or determined and compared. For example, the states of the qubits may be compared in the following squares 40+41+43+44, 43+44+46+47, 41+42+44+45 and 44+45+47+48. Also, the qubits 41, 43, 35 and 47 may be compared using qubit 44 as an ancilla qubit. The same may be done for the qubits 40+41+43+44 if an ancilla qubit was provided within the hatched square between these.

Also, the edges may be compared by comparing pairs of qubits, such as 40+41, 41+42, 42+45 and so on.

In one situation, the squares with horizontal stripes are used for determining one type of difference or one type of manipulation, such as a spin flip, and the other, here with vertical stripes, for another type of manipulation, such as a phase change. Also the edges having only 2 qubits may be used in the same manner.

If a difference or discrepancy of the states is determined, it is determined which qubit(s) should be manipulated—and how to manipulate the qubit.

One manner of determining a state of a qubit or comparing states of qubits is to use a so-called CNOT circuit (conditional NOT) 49 which is able to detect a state of a qubit without affecting this state. In some situations, one CNOT circuit is provided for each qubit and the CNOT outputs for each group collected and compared. From the collective outputs, it may be determined which qubit(s) are not aligned with the others and thus need manipulation.

In singlet-triplet qubits, two manipulations are often selected between, if a manipulation is required: a spin flip, often called X errors, and a phase shift, often called a Z error.

In FIG. 6, a set-up where each qubit, seen as a horizontal line, of a square is connected to a CNOT gate 49. The output of the CNOTs 49 are combined into an output which then describes whether one of the qubits has a state different than the others. If the qubits in pairs have different states, other measures are required. If a qubit has a Z error, the ancilla qubit 50, which could be provided within a square of FIG. 5, will be flipped, which may be easily determined.

In FIG. 7, a set-up where, again, each qubit, seen as a horizontal line, of a square is connected to the ancilla qubit 50 via a CNOT gate 49. If a qubit has an X error, the output of the corresponding CNOT will be flipped. Thus, if one of the qubits has an X error, the output of the ancilla qubit 50 will be flipped, which may be easily determined.

Based on the output of the ancilla qubits, it may be determined which qubits 40-48 needs manipulation and which manipulation is required.

As described, one of the manipulations may be achieved by (see FIG. 3) bringing the qubit to the top of the A curve, where the superposition is seen. This superposition will have the two particle spins rotate, and the desired manipulation may be selected by remaining at the top position for a period of time required for achieving the rotation or manipulation desired.

Another manipulation may be obtained by providing a difference in magnetic field between the two positions of the qubit caused by local nuclear spins. This rotation is most effective if both charges are in the two different storage locations. Thus, by choosing the operating point of DV3pa in FIG. 3, it is possible to select which rotation (X or Z) is stronger and basically set an angle for the rotation. As described in “Universal quantum control of two-electron spin quantum bits using dynamic nuclear polarization”, S. Foletti et al., Nature Physics 5(2009), this facilitates two-axis control. The strength of the magnetic field difference caused by nuclear spins can also be controlled by pulse sequences to polarize these nuclear spins.

Then, again the charge in the position 36 may be utilized, as it in the same manner may affect the manipulation of the qubit when a desired signal is fed to the qubit.

More precisely, a signal may be fed to all qubits 40-48 to perform a bit flip. The qubits needing this manipulation may be provided a charge and the others not. Then, only the qubits with the charge will experience a bit flip. Then, a signal may be fed to the qubits to perform a phase shift and the qubits needing this manipulation are provided with a charge.

Thus, any manipulation desired of a qubit may be performed by feeding a “universal” signal to all qubits and providing a charge next to it, if the manipulation defined by the signal is desired in this qubit.

Clearly, then signals may be fed sequentially to all qubits, which signals individually define different manipulations. For example, a first signal may define a phase shift and a next signal may define a spin flip. A third signal may be an initialization in a particular state.

Then, the manipulation of each individual qubit may be controlled by positioning a charge next to that qubit when the desired or corresponding signal is provided, and otherwise no charge may be provided to prevent the qubit from experiencing the manipulation.

Then, a method may be set-up comprising the steps of:
Initializing the qubits to a particular state,
Performing a first portion of a desired operation of the qubits,
Reading-out the errors of the qubits and determining, if any, a manipulation for each qubit,
Feeding a first signal to the qubits while providing a charge next to the qubits requiring the corresponding first manipulation,
Optionally feeding a second signal to the qubits while providing a charge next to the qubits requiring the corresponding second manipulation,
Optionally feeding a third signal to the qubits while providing a charge next to the qubits requiring the corresponding third manipulation,
Performing a second portion of a desired operation of the qubits.

It may be desired for optimal or correct operation of the qubits that no particle is present (or that a particle is always present) in the conditioning storage element during standard operation.

Thus, as mentioned above, the qubits 40-48 may be provided in one layer, such as in a predetermined pattern, where the conditioning storage elements may be provided in another, parallel layer, such as together with the reservoir(s) and/or the additional storage elements.

In a particularly interesting embodiment, not only the reading-out of the errors of the qubits is performed locally or at least at cryogenic or low temperatures, but also the determination of which qubits should receive a charge an optionally also when the charge(s) is/are fed to the conditioning storage elements.

In one situation, Boolean circuits or gates may be provided or generated even at cryogenic temperatures by the gates described above as described in Applicant's co-pending application. Then, a circuit may be provided for each qubit which receives the states of the qubits or the states thereof or the result of the comparisons and determines, based on the input, whether the qubit requires manipulation. The determination of whether the qubit requires manipulation may be performed along the lines of the prior art.

Different circuits may be provided for different manipulations. Then, the output of a circuit, which could be a charge or not, may be output in a timed fashion so that the output is fed to the conditioning storage position when the signal for the pertaining manipulation is fed to the qubit.

In the above examples and embodiments, the manipulation is exemplified as taking place when a charge is provided next to the qubit. It is equally relevant to have the manipulation take place when there is no charge close to the qubit, where the presence of a charge will prevent the manipulation. This merely requires a corresponding amendment of the signal(s) fed to the qubits.

### Aspects

1. An assembly comprising:
a qubit configured to represent each one of two states,
a conditioning storage element positioned, relative to the qubit, so that a charge stored in the storage element will provide an electrical field at the qubit, the conditioning storage element being configured to alter a total charge within a distance of 200 nm from the qubit, and
an supplying/altering means configured to alter the qubit.

2. An assembly according to aspect 1, further comprising:
an additional storage element and a transferring element capable of transporting one or more charged particles between the additional storage element and the conditioning storage element, a distance of at least 200 nm existing between the additional storage element and the conditioning storage element.

3. An assembly according to aspect 1 or 2, further comprising a reservoir and a transferring element capable of transporting one or more charged particles between the conditioning storage element and the reservoir.

4. An assembly according to any of the preceding aspects, wherein the qubit comprises two or more storage locations each capable of holding a charged particle having a spin, and wherein the conditioning storage position is positioned closer to one of the storage locations than another of the storage locations.

5. An assembly according to any of the preceding aspects, wherein the supplying/altering means is configured to receive a signal and provide a corresponding electrical field to the qubit.

6. An assembly according to aspect 4 or 5, wherein the supplying/altering means comprises a generating means for providing a first potential at the first storage element, a second potential at the second storage element and a central potential at a position between the first and second storage elements.

7. An assembly according to any of the preceding aspects, wherein the supplying/altering means are configured to alter a spin direction of the qubit.

8. An assembly according to any of the preceding aspects, wherein supplying/altering means are configured to alter a phase of the qubit.

9. An assembly according to any of the preceding aspects, further comprising:
one or more additional qubits,
means for converting a state of each additional qubit into a converted charge, a logical circuit configured to receive the converted charge(s) from the converting means and provide the charge to the storage element.

10. A system comprising a plurality of assemblies according to any of aspects 5-9, further comprising a signal input and a distributing element configured to feed a received signal to all supplying/altering means.

11. A system according to aspect 11, further comprising a feeding element configured to feed a charge to the conditioning storage element(s) of one or more predetermined qubits of the qubits.

12, A system according to aspect 11, further comprising generating elements configured to:
a. generate information from a state of each of the qubits,
b. identify one or more first qubits of the qubits and
c. control the feeding element to provide a charge in the conditioning storage element(s) of the identified first qubit(s).

12. A system according to aspect 11, wherein the feeding element is configured to feed the charges (step c.) before or when a first received signal is fed to the supplying/altering means.

13. A system according to aspect 12, wherein the generating means are configured to: subsequent to step b. identify one or more second qubits of the qubits and before or after step c. control the feeding element to provide a charge in the conditioning storage element(s) of the identified second qubit(s).

14. A system according to aspect 13, wherein the feeding element is configured to provide the charge(s) to the identified second qubit(s) before or when a second received signal is fed to the supplying/altering means.

15. A method of operating an assembly comprising:
a qubit,
a conditioning storage element positioned, relative to the qubit, so that any charge stored in the conditioning storage element will provide an electrical field at the qubit, the conditioning storage element being configured to alter a total charge within a distance of 200 nm from the qubit and
an supplying/altering means,
the method comprising the steps of:
when no charge is provided in the conditioning storage element, altering the qubit to a first state or phase, and
when a charge is provided in the conditioning storage element, altering the qubit to another state or another phase.

16. A method according to aspect 15, wherein the qubit comprises a first and a second storage element each configured to hold a particle having a spin, and wherein the supplying/altering means comprises a generating means,
the method comprising the steps of:
the generating means providing the first potential at the first storage element, the second potential at the second storage element and the central potential at a position between the first and second storage elements,
the conditioning storage element holding a charge generating a first field strength at the first storage element and a second field strength at the second storage element, the first and second field strengths being different from each other.

17. A method according to aspect 16, the method further comprising the steps of, when there is no charge in the conditioning storage position:
a) providing a first signal to the generating means, causing the generating means to alter one or more of the central potential and the first and second potentials to have one of the first and second potentials lower than the other to provide both particles in the lower potential storage position,
b) providing a second signal to the generating means causing the generating means to have the central potential larger than both the first potential and the second potential, generating two potential wells,
c) providing a third signal to the generating means causing the generating means to alter the first and second potentials to potentials causing the particles will get into a superposition of being both in the same potential well and being each in a separate potential well, before moving back to the second signal as provided in b).

18. A method according to aspect 17, wherein step c) comprises maintaining the first and second potentials for a predetermined period of time before returning to the second signal provided in b).

19. A method of aspect 17 or 18, the method comprising the steps of, when the charge is provided in the conditioning storage position:
initially providing the first signal to the generating means,
then, providing the second signal to the generating means,
then, providing the third signal to the generating means, and
finally providing the second signal to the generating means,
where the field from the charge in the conditioning storage position operates to alter the difference in potential between the first and second storage elements.

20. A method according to any of aspects 15-19, wherein the supplying/altering means is configured to alter a spin direction of the qubit either when the charge is provided in the conditioning storage element or when no charge is provided in the conditioning storage element.

21. A method according to any of aspects 15-20, wherein the supplying/altering means is configured to alter a phase of the qubit either when the charge is provided in the conditioning storage element or when no charge is provided in the conditioning storage element.

22. A method according to any of aspects 15-21 further comprising the steps of:
for each of one or more additional qubits, generating a converted charge from a state of the additional qubit,
deriving, from the converted charge(s), a charge and providing the charge in the conditioning storage element.

23. A method of operating a system comprising a plurality of assemblies according to any of aspects 5-9, the method comprising receiving a received signal and forwarding the received signal to all supplying/altering means.

24. A method according to aspect 23, further comprising the step of feeding a charge to the conditioning storage element(s) of one or more predetermined qubits of the qubits.

25. A method according to aspect 24, further comprising the steps of:
a. generating information from a state of each of the qubits,
b. identifying one or more first qubits of the qubits and
c. feeding a charge to the conditioning storage element(s) of the identified first qubit(s).

26. A method according to aspect 25, wherein the feeding step comprises feeding the charges (step c.) when or before a first received signal is fed to the supplying/altering means. 27. A method according to aspect 26, further comprising the steps of:
subsequent to step b. identifying one or more second qubits of the qubits and
before or after step c. feeding a charge in the conditioning storage element(s) of the identified second qubit(s).

28. A method according to aspect 27, wherein the charge(s) are fed to the identified second qubit(s) before or when a second received signal is fed to the supplying/altering means.

1.-15. (canceled)

16. An assembly comprising:
a first qubit configured to hold one or more charged particles and being configured to represent each one of two states,
one or more electrodes positioned so as to provide one or more electrical fields to the first qubit,
a conditioning storage element having a centre positioned within a distance of 200 nm from a centre of the first qubit,
one or more additional qubits each configured to hold one or more charged particles,
means for converting a state of each additional qubit into a converted charge,
a logical circuit configured to receive the converted charge(s) from the converting means and combine these into a resulting charge and provide the resulting charge to the conditioning storage element and
means for repeatedly supplying a predetermined signal to each of the one or more electrodes so that:
a) it brings the qubit to a first state by the supplying means feeding the predetermined signal to each of the one or more electrodes while the conditioning storage element comprises a first number of charged particles, and
b) it brings the qubit to a second state by the supplying means feeding the predetermined signal to each of the one or more electrodes while the conditioning storage element comprises a second number of charged particles,
wherein the first and second numbers of charged particles are different numbers of charged particles and wherein the first and second states/phases are different states/phases.

17. The assembly comprising:
a first qubit configured to hold one or more charged particles and being configured to represent each one of two states,
one or more electrodes positioned so as to provide one or more electrical fields to the first qubit,
a conditioning storage element having a centre positioned within a distance of 200 nm from a centre of the first qubit,
one or more additional qubits each configured to hold one or more charged particles,
means for converting a state of each additional qubit into a converted charge,
a logical circuit configured to receive the converted charge(s) from the converting means and combine these into a resulting charge and provide the resulting charge to the conditioning storage element and
means for repeatedly supplying a predetermined signal to each of the one or more electrodes so that:
c) it brings the qubit to a first phase by the supplying means feeding the predetermined signal to each of the one or more electrodes while the conditioning storage element comprises a first number of charged particles, and
d) it brings the qubit to a second phase by the supplying means feeding the predetermined signal to each of the one or more electrodes while the conditioning storage element comprises a second number of charged particles,
wherein the first and second numbers of charged particles are different numbers of charged particles and wherein the first and second states/phases are different states/phases.

18. The assembly according to claim 16, wherein the supplying means is configured to receive a first signal and provide the predetermined signal to the one or more electrodes.

19. The assembly according to claim 16, wherein the supplying means are configured to alter a spin direction of the qubit and/or a phase of the qubit.

20. A system comprising a plurality of assemblies according to claim 16, further comprising a signal input for receiving an input signal and a distributing element configured to feed the predetermined signal to all supplying means.

21. The system according to claim 20, further comprising a feeding element configured to feed a charge to the conditioning storage element(s) of one or more predetermined qubits of the qubits.

22. The system according to claim 21, further comprising generating elements configured to:
(a) generate information from a state of each of the qubits,
(b) identify one or more first qubits of the qubits and
(c) control the feeding element to provide a charge in the conditioning storage element(s) of the identified first qubit(s).

23. The system according to claim 22, wherein the feeding element is configured to provide the charges before or when a first received signal is fed to the supplying means.

24. The system according to claim 22, wherein the generating means are configured to:
subsequent to step (b) identify one or more second qubits of the qubits and
before or after step (c) control the feeding element to provide a charge in the conditioning storage element(s) of the identified second qubit(s).

25. A method of operating an assembly comprising:
a first qubit configured to hold one or more charged particles and being configured to represent each one of two states,
one or more additional qubits each configured to hold one or more charged particles,
one or more electrodes positioned so as to provide one or more electrical fields to the first qubit,
means for supplying a signal to each of the one or more electrodes, a logical circuit, and a conditioning storage element having a centre positioned within a distance of 200 nm from a centre of the first qubit,
the method comprising the steps of:
generating a converted charge from a state of each additional qubit,
combining, in the logical circuit, the converted charge(s) into a resulting charge and providing the resulting charge in the conditioning storage element,
bringing the qubit to a first state by the supplying means feeding a predetermined signal to each of the one or more electrodes while the conditioning storage element comprises a first number of charged particles, and
bringing the qubit to a second state by the supplying means feeding the predetermined signal to each of the one or more electrodes while the conditioning storage element comprises a second number of charged particles,
wherein the first and second numbers of charged particles are different numbers of charged particles and wherein the first and second states are different states.

26. A method of operating an assembly comprising:
a first qubit configured to hold one or more charged particles and being configured to represent each one of two states,
one or more additional qubits each configured to hold one or more charged particles,
one or more electrodes positioned so as to provide one or more electrical fields to the first qubit,
means for supplying a signal to each of the one or more electrodes,
a logical circuit, and
a conditioning storage element having a centre positioned within a distance of 200 nm from a centre of the first qubit,
the method comprising the steps of:
generating a converted charge from a state of each additional qubit,
combining, in the logical circuit, the converted charge(s) into a resulting charge and providing the resulting charge in the conditioning storage element bringing the qubit to a first phase by the supplying means feeding a predetermined signal to each of the one or more electrodes while the conditioning storage element comprises a first number of charged particles, and
bringing the qubit to a second phase by the supplying means feeding the predetermined signal to each of the one or more electrodes while the conditioning storage element comprises a second number of charged particles,
wherein the first and second numbers of charged particles are different numbers of charged particles and wherein the first and second phases are different phases.

27. The method according to claim 25, wherein the qubit comprises a first and a second storage element each configured to hold a particle having a spin, and
wherein the bringing of the qubit to the first state comprises providing a first potential at the first storage element, a second potential at the second storage element and a central potential at a position between the first and second storage elements, and the first number of charged particles in the conditioning storage element generate a first field strength at the first storage element and a second field strength at the second storage element, the first and second field strengths being different from each other.

28. The method according to claim 25, the method comprising receiving an input signal, operating a plurality of the assemblies and forwarding the predetermined signal to all supplying means.

29. The method according to claim 28, further comprising the step of feeding a charge to the conditioning storage element(s) of one or more predetermined qubits of the qubits.

30. The method according to claim 29, further comprising the steps of:
(a) generating information from a state of each of the qubits,
(b) identifying one or more first qubits of the qubits and
(c) feeding a charge to the conditioning storage element(s) of the identified first qubit(s).
